(19) United States
(12) Patent Application Publication
(10) Pub. No.: US 2023/0186607 A1
(43) Pub. Date: Jun. 15, 2023

(54) MULTI-TASK IDENTIFICATION METHOD, TRAINING METHOD, ELECTRONIC DEVICE, AND STORAGE MEDIUM

(71) Applicant: Beijing Baidu Netcom Science Technology Co., Ltd., Beijing (CN)

(72) Inventors: Nan PENG, Beijing (CN); Bi LI, Beijing (CN); Teng XI, Beijing (CN); Gang ZHANG, Beijing (CN)

(21) Appl. No.: 18/148,174

(22) Filed: Dec. 29, 2022

(30) Foreign Application Priority Data
Mar. 30, 2022 (CN) 202210335573.4

(51) Int. Cl. G06V 10/771; G06V 10/774; G06V 10/72; G06V 10/77

(52) U.S. Cl. CPC G06V 10/771; G06V 10/774; G06V 10/72; G06V 10/7715

(57) ABSTRACT

A multi-task identification method, a training method, an electronic device, and a storage medium are provided, which relate to a field of an artificial intelligence technology, in particular to fields of deep learning, image processing and computer vision technologies, and may be applied to scenarios such as human faces. A specific implementation solution includes: obtaining first intermediate feature data according to an image to be identified; selecting a feature extraction strategy having a greatest matching degree with the image to be identified from a plurality of feature extraction strategies based on a target selection strategy and the first intermediate feature data, so as to obtain a target feature extraction strategy; processing the first intermediate feature data based on the target feature extraction strategy, to obtain second intermediate feature data; and obtaining a multi-task identification result for the image to be identified according to the second intermediate feature data.

### CROSS-REFERENCE TO RELATED APPLICATION(S)

This application claims the benefit of Chinese Patent Application No. 202210335573.4 filed on Mar. 30, 2022, the whole disclosure of which is incorporated herein by reference.

### TECHNICAL FIELD

The present disclosure relates to a field of an artificial intelligence technology, in particular to fields of deep learning, image processing, and computer vision technologies, and may be applied to scenarios such as human faces. Specifically, the present disclosure relates to a multi-task identification method, a training method, an electronic device, and a storage medium.

### BACKGROUND

With a development of a computer technology, the artificial intelligence technology has also been developed. The artificial intelligence technology may include a computer vision technology, a speech identification technology, a natural language processing technology, a machine learning, a deep learning, a big data processing technology and a knowledge graph technology, etc.

The artificial intelligence technology has been widely used in various fields. For example, the artificial intelligence technology may be used to perform a multi-task identification.

### SUMMARY

The present disclosure provides a method of training a model, a method of determining an asset valuation, a device, and a storage medium.

According to an aspect of the present disclosure, A multi-task identification method, including: obtaining first intermediate feature data according to an image to be identified; selecting a feature extraction strategy having a greatest matching degree with the image to be identified from a plurality of feature extraction strategies based on a target selection strategy and the first intermediate feature data, so as to obtain a target feature extraction strategy; processing the first intermediate feature data based on the target feature extraction strategy, so as to obtain second intermediate feature data; and obtaining a multi-task identification result for the image to be identified according to the second intermediate feature data.

According to another aspect of the present disclosure, a method of training a deep learning model is provided, including: obtaining first intermediate sample feature data according to a sample image; selecting a sample feature extraction strategy having a greatest matching degree with the sample image from a plurality of sample feature extraction strategies based on a selection strategy and the first intermediate sample feature data, so as to obtain a target sample feature extraction strategy; processing the first intermediate sample feature data based on the target sample feature extraction strategy, so as to obtain second intermediate sample feature data; obtaining a multi-task identification result for the sample image according to the second intermediate sample feature data; and training the deep learning model by using the multi-task identification result for the sample image and a label value of the sample image, so as to obtain a trained deep learning model.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the methods described in the present disclosure.

According to another aspect of the present disclosure, a non-transitory computer-readable storage medium having computer instructions therein is provided, and the computer instructions are configured to cause a computer to implement the methods described in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a multi-task identification method and apparatus and a method and apparatus of training a deep learning model may be applied according to embodiments of the present disclosure;

FIG. 2 schematically shows a flowchart of a multi-task identification method according to embodiments of the present disclosure;

FIG. 3 schematically shows a flowchart of obtaining first intermediate feature data according to an image to be identified according to embodiments of the present disclosure;

FIG. 4 schematically shows a flowchart of selecting a feature extraction strategy having a greatest matching degree with an image to be identified from a plurality of feature extraction strategies based on a target selection strategy and first intermediate feature data to obtain a target feature extraction strategy according to embodiments of the present disclosure;

FIG. 5 schematically shows a flowchart of processing first intermediate feature data based on a target feature extraction strategy to obtain second intermediate feature data according to embodiments of the present disclosure;

FIG. 6 schematically shows a flowchart of obtaining a multi-task identification result for an image to be identified according to second intermediate feature data according to embodiments of the present disclosure;

FIG. 7 schematically shows a schematic example diagram of a multi-task identification method according to embodiments of the present disclosure;

FIG. 8 schematically shows a flowchart of a method of training a deep learning model according to embodiments of the present disclosure;

FIG. 9A schematically shows a schematic example diagram of a deep learning model according to embodiments of the present disclosure;

FIG. 9B schematically shows a schematic example diagram of a backbone sub-module according to embodiments of the present disclosure;

FIG. 10 schematically shows a schematic diagram of a method of training a deep learning model according to embodiments of the present disclosure;

FIG. 11 schematically shows a block diagram of a multi-task identification apparatus according to embodiments of the present disclosure;

FIG. 12 schematically shows a block diagram of an apparatus of training a deep learning model according to embodiments of the present disclosure; and

FIG. 13 schematically shows a block diagram of an electronic device suitable for implementing a multi-task identification method and a method of training a deep learning model according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In a field of a computer vision identification, a process of training an identification model is to pre-train using a general public sample set, and then fine-tune a model parameter of a pre-trained identification model by using samples of a downstream identification task, so as to obtain the identification model. Based on the above method, the identification model corresponding to the downstream identification task may be obtained by fine-tuning the pre-trained identification model, a convergence speed of the model is faster, and a consumption of computing resources is reduced. In addition, since some downstream identification tasks have a small number of samples, the above method may achieve a higher identification accuracy than direct training.

However, a data distribution of downstream identification tasks may be different from that of general public samples, and there may be a catastrophic forgetting problem in the fine-tuning stage, which affects the identification accuracy. If a multi-task identification is performed in the pre-training stage, that is, if data similar to the data of the downstream identification task participates in the model training in the pre-training stage, the catastrophic forgetting problem in the fine-tuning stage may be effectively avoided, so that the identification accuracy of the downstream identification task may be further improved. Therefore, a research of the multi-task identification is an important topic in the field of computer vision identification. There is a need to design an appropriate multi-task identification solution to improve the accuracy of multi-task identification.

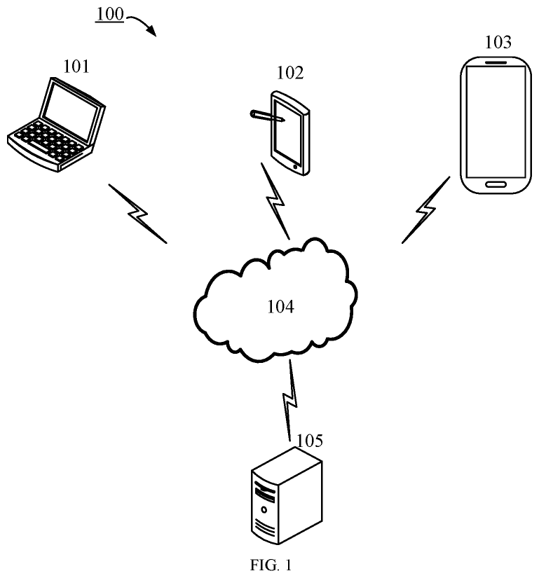

FIG. 1 schematically shows an exemplary system architecture to which a multi-task identification method and apparatus and a method and apparatus of training a deep learning model may be applied according to embodiments of the present disclosure.

It should be noted that FIG. 1 is merely an example of a system architecture to which embodiments of the present disclosure may be applied to help those skilled in the art understand the technical content of the present disclosure, but it does not mean that embodiments of the present disclosure may not be applied to other devices, systems, environments or scenarios. For example, in other embodiments, an exemplary system architecture to which a multi-task identification method and apparatus and a method and apparatus of training a deep learning model may be applied may include a terminal device, but the terminal device may implement the multi-task identification method and apparatus and the method and apparatus of training the deep learning model provided in embodiments of the present disclosure without interacting with a server.

As shown in FIG. 1, a system architecture 100 according to such embodiments may include terminal devices 101, 102, 103, a network 104, and a server 105. The network 104 is used as a medium for providing a communication link between the terminal devices 101, 102, 103 and the server 105. The network 104 may include various connection types, such as wired and/or wireless communication links, and the like.

The terminal devices 101, 102 and 103 may be used by a user to interact with the server 105 through the network 104, so as to send or receive messages, etc. The terminal devices 101, 102 and 103 may be installed with various communication client applications, such as knowledge reading applications, web browser applications, search applications, instant messaging tools, mailbox clients and/or social platform software, etc. (for example only).

The terminal devices 101, 102 and 103 may be various electronic devices having display screens and supporting web browsing, including but not limited to smartphones, tablet computers, laptop computers, desktop computers, and so on.

The server 105 may be various types of servers providing various services. For example, the server 105 may be a cloud server, also known as a cloud computing server or a cloud host, which is a host product in a cloud computing service system to solve shortcomings of difficult management and weak service scalability existing in an existing physical host and VPS (Virtual Private Server) service. The server 105 may also be a server of a distributed system or a server combined with a block-chain.

It should be noted that the multi-task identification method provided by embodiments of the present disclosure may generally be performed by the terminal device 101, 102 or 103. Accordingly, the multi-task identification apparatus provided by embodiments of the present disclosure may also be arranged in the terminal device 101, 102 or 103.

Alternatively, the multi-task identification method provided by embodiments of the present disclosure may generally be performed by the server 105. Accordingly, the multi-task identification apparatus provided by embodiments of the present disclosure may be generally arranged in the server 105. The multi-task identification method provided by embodiments of the present disclosure may also be performed by a server or server cluster different from the server 105 and capable of communicating with the terminal devices 101, 102, 103 and/or the server 105. Accordingly, the multi-task identification apparatus provided by embodiments of the present disclosure may also be arranged in a server or server cluster different from the server 105 and capable of communicating with the terminal devices 101, 102, 103 and/or the server 105.

It should be noted that the method of training the deep learning model provided by embodiments of the present disclosure may generally be performed by the server 105. Accordingly, the apparatus of training the deep learning model provided by embodiments of the present disclosure may be generally arranged in the server 105. The method of training the deep learning model provided by embodiments of the present disclosure may also be performed by a server or server cluster different from the server 105 and capable of communicating with the terminal devices 101, 102, 103 and/or the server 105. Accordingly, the apparatus of training the deep learning model provided by embodiments of the present disclosure may also be arranged in a server or server cluster different from the server 105 and capable of communicating with the terminal devices 101, 102, 103 and/or the server 105.

Alternatively, the method of training the deep learning model provided by embodiments of the present disclosure may generally be performed by the terminal device 101, 102 or 103. Accordingly, the apparatus of training the deep learning model provided by embodiments of the present disclosure may also be arranged in the terminal device 101, 102 or 103.

It should be understood that a number of terminal devices, network and server in FIG. 1 are merely schematic. According to implementation needs, any number of terminal devices, networks and servers may be provided.

It should be noted that a sequence number of each operation in the following methods is merely used to represent the operation for ease of description, and should not be regarded as indicating an execution order of each operation. Unless explicitly stated, the methods do not need to be performed exactly in the order shown.

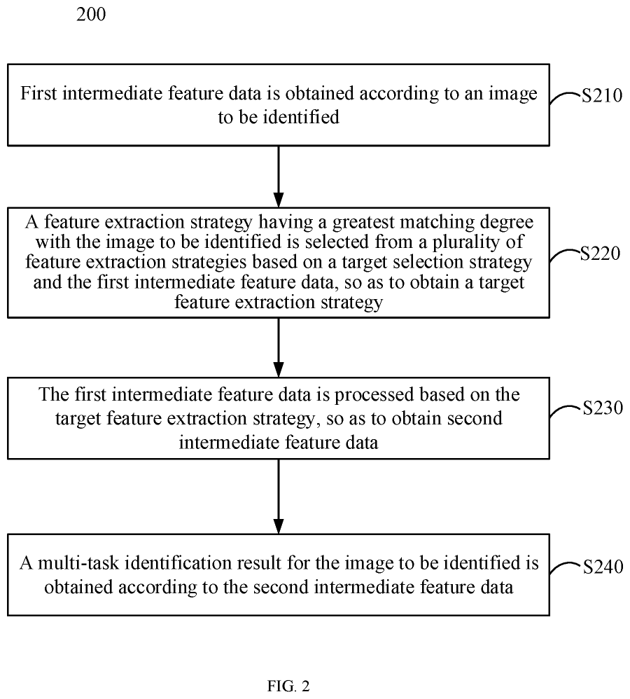

FIG. 2 schematically shows a flowchart of a multi-task identification method according to embodiments of the present disclosure.

As shown in FIG. 2, a method 200 includes operations S210 to S240.

In operation S210, first intermediate feature data is obtained according to an image to be identified.

In operation S220, a feature extraction strategy having a greatest matching degree with the image to be identified is selected from a plurality of feature extraction strategies based on a target selection strategy and the first intermediate feature data, so as to obtain a target feature extraction strategy.

In operation S230, the first intermediate feature data is processed based on the target feature extraction strategy, so as to obtain second intermediate feature data.

In operation S240, a multi-task identification result for the image to be identified is obtained according to the second intermediate feature data.

According to embodiments of the present disclosure, the image to be identified may refer to an image requiring a multi-task identification. The multi-task identification may refer to image identification for a plurality of tasks. The multi-task identification may include at least two selected from: an anti-spoofing identification, a sign board identification, an obstacle identification, a building identification, or a vehicle identification. The anti-spoofing identification may include at least one selected from a face identification and a body identification. The body identification may include a body action behavior identification. The image to be identified may include at least one selected from: an image of a living body to be identified, an image of a sign board to be identified, an image of an obstacle to be identified, an image of a building to be identified, or an image of a vehicle to be identified. The image of the living body to be identified may include at least one selected from a face image to be identified and a body image to be identified.

According to embodiments of the present disclosure, the target selection strategy may refer to a strategy for determining the feature extraction strategy having the greatest matching degree with the image to be identified from the plurality of feature extraction strategies. The target selection strategy may have a model structure corresponding to the target selection strategy. That is, the selection of the target feature extraction strategy having the greatest matching degree with the image to be identified from the plurality of feature extraction strategies according to the first intermediate feature data may be implemented by using the model structure corresponding to the target selection strategy. For example, the model structure corresponding to the target selection strategy may include an expert selection unit. The greatest matching degree with the image to be identified may mean that it is expected that an identification accuracy determined according to the multi-task identification result for the image to be identified may reach an expected identification accuracy. The expected identification accuracy may include a maximum identification accuracy. The target selection strategy may include target parameter data related to selecting the target feature extraction strategy. The target parameter data may be an element value in a matrix. The target parameter data may be determined according to a set of historical images and a multi-task identification result obtained by performing a multi-task identification on the set of historical images. The set of historical images may include historical images respectively corresponding to the plurality of tasks.

According to embodiments of the present disclosure, the feature extraction strategy may refer to a strategy that may be used to process feature data of an image to be identified. The target feature extraction strategy may refer to the feature extraction strategy having the greatest matching degree with the image to be identified. The feature extraction strategy may be used to extract at least one of a global feature and a local feature of the first intermediate feature data. The feature extraction strategy may have a feature extraction model structure corresponding to the feature extraction strategy. That is, the feature extraction strategy for extracting at least one of the global feature and the local feature of the first intermediate feature data may be implemented by using the feature extraction model structure.

According to embodiments of the present disclosure, the first intermediate feature data may include first category feature data. The second intermediate feature data may include second category feature data. The category feature data may refer to data related to a category dimension of an image in a task.

According to embodiments of the present disclosure, the multi-task identification result may indicate a target category of a target task to which the image to be identified belongs. The target task may be a task having a highest possibility among the plurality of tasks. The target category may be a category having a highest possibility among the plurality of categories. The possibility may be represented by a probability value. A relationship between the possibility and the probability value may be configured according to actual service requirements, which is not limited here. For example, the larger the probability value, the higher the possibility. Alternatively, the smaller the probability value, the higher the possibility.

According to embodiments of the present disclosure, the image to be identified may be processed to obtain the first intermediate feature data. The first intermediate feature data may include first category feature data. In addition, the first intermediate feature data may further include first image feature data. The target feature extraction strategy may be selected from the plurality of feature extraction strategies according to a result obtained by processing the first intermediate feature data based on the target selection strategy. Then, the first intermediate feature data may be processed by using the target feature extraction strategy, so as to obtain second intermediate feature data. The second intermediate feature data may include second category feature data. Category probability values of the images to be identified respectively belonging to the plurality of tasks may be obtained according to the first category feature data. The multi-task identification result indicating the target category of the target task to which the image to be identified belongs may be determined according to the category probability values of the image to be identified respectively belonging to the plurality of tasks.

According to embodiments of the present disclosure, operations S210 to S240 may be performed by an electronic device. The electronic device may include a server or a terminal device. The server may be the server 105 in FIG. 1. The terminal device may be the terminal device 101, the terminal device 102 or the terminal device 103 in FIG. 1.

According to embodiments of the present disclosure, the first intermediate feature data is processed by using the target feature extraction strategy having the greatest matching degree with the image to be identified that is selected from the plurality of feature extraction strategies based on the target selection strategy, so as to obtain the second intermediate feature data, and then a multi-task identification result for the image to be identified may be obtained according to the second intermediate feature data. The image to be identified has a target feature extraction strategy corresponding to the image to be identified, and different images to be identified may have the same or different target feature extraction strategies. Therefore, it is possible to dynamically select the target feature extraction strategy for the image to be identified, so that a degree of coupling of feature extraction strategies between different images to be identified may be reduced. On this basis, since the target feature extraction strategy has the greatest matching degree with the image to be identified, the multi-task identification result obtained by processing the first intermediate feature data based on the target feature extraction strategy may have a high multi-task identification accuracy.

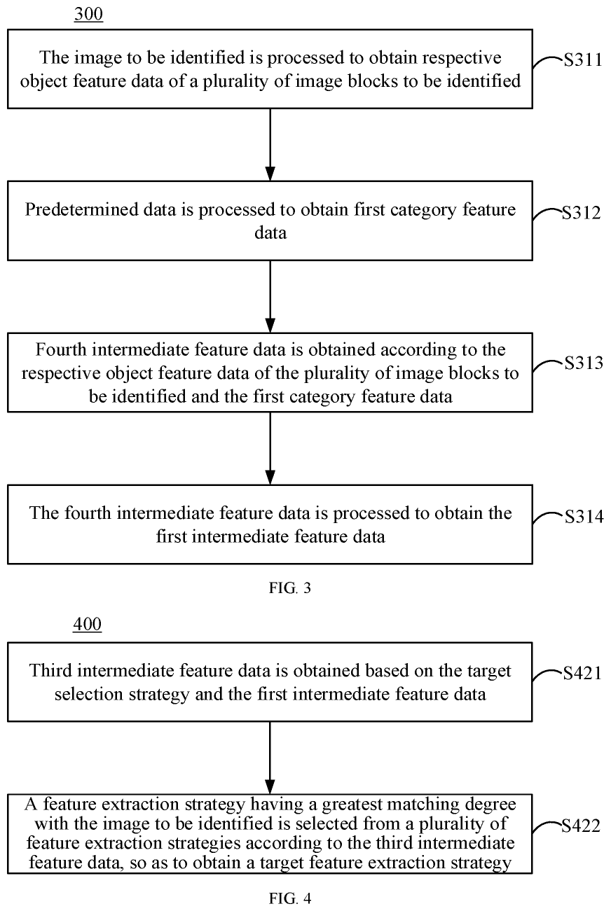

The multi-task identification method according to embodiments of the present disclosure will be further described below with reference to FIG. 3 to FIG. 6 in conjunction with specific embodiments.

FIG. 3 schematically shows a flowchart of obtaining the first intermediate feature data according to the image to be identified according to embodiments of the present disclosure.

As shown in FIG. 3, a method 300 is a further definition of operation S210 in FIG. 2, and the method 300 includes operations S311 to S314.

In operation S311, the image to be identified is processed to obtain respective object feature data of a plurality of image blocks to be identified.

In operation S312, predetermined data is processed to obtain first category feature data.

In operation S313, fourth intermediate feature data is obtained according to the respective object feature data of the plurality of image blocks to be identified and the first category feature data.

In operation S314, the fourth intermediate feature data is processed to obtain the first intermediate feature data.

According to embodiments of the present disclosure, the predetermined data may refer to data related to a generation of the first category feature data. The first category feature data may refer to data related to the image to be identified in a category dimension of the task. The category dimension may include at least one selected from: at least one category related to anti-spoofing identification, at least one category related to sign board identification, at least one category related to obstacle identification, at least one category related to building identification, or at least one category related to vehicle identification. The at least one category related to the anti-spoofing identification may include at least one selected from: at least one category related to face identification and at least one category related to body identification.

For example, the at least one category related to face identification may include at least one selected from: an elderly category, a middle-aged category, a youth category, an early-youth category, a child category, or an infant category. The at least one category related to body identification may include at least one selected from a walking action category or a sports action category. The at least one category related to vehicle identification may include at least one selected from: a passenger vehicle category or a commercial vehicle category. The passenger vehicle category may include at least one selected from: a basic passenger vehicle category, a multipurpose vehicle category, a sport utility vehicle category, or other vehicle categories. The commercial vehicle category may include at least one selected from: a passenger vehicle category, a cargo vehicle category, a semi-trailer vehicle category, an incomplete passenger vehicle category, or an incomplete cargo vehicle category.

According to embodiments of the present disclosure, an image may include a plurality of image blocks. The image blocks may be obtained by dividing the image. A size of the image block may be configured according to actual service requirements, which is not limited here. Different image blocks may have the same size. The object feature data may refer to feature data of the image block. For the image to be identified, the image to be identified may include a plurality of image blocks to be identified. The image block to be identified may be obtained by dividing the image to be identified. Different image blocks to be identified may have the same size.

According to embodiments of the present disclosure, the image to be identified and the predetermined data may be acquired. The image to be identified may be processed to obtain a plurality of image blocks to be identified. The plurality of image blocks to be identified may be processed to obtain respective object feature data of the plurality of image blocks to be identified. The predetermined data may be processed to obtain the first category feature data.

According to embodiments of the present disclosure, the first category feature data and the respective object feature data of the plurality of images to be identified may be concatenated to obtain fourth intermediate feature data. For example, the first category feature data may be provided at a predetermined position, and concatenated with the respective object feature data of the plurality of image blocks to be identified, so as to obtain the fourth intermediate feature data. The predetermined position may be configured according to actual service requirements, which is not limited here. For example, the plurality of image blocks to be identified of the image to be identified may form a sequence of image blocks to be identified. The predetermined position may be a position before a starting position of the sequence of image blocks to be identified. Alternatively, the predetermined position may be a position after an end position of the sequence of image blocks to be identified.

According to embodiments of the present disclosure, after the fourth intermediate feature data is obtained, at least one of a global feature and a local feature of the fourth intermediate feature data may be extracted to obtain the first intermediate feature data. That is, the global feature may be extracted from the fourth intermediate feature data to obtain the first intermediate feature data. Alternatively, the local feature may be extracted from the fourth intermediate feature data to obtain the first intermediate feature data. Alternatively, the global feature and the local feature may be extracted from the fourth intermediate feature data to obtain the first intermediate feature data.

According to embodiments of the present disclosure, operations S311 to S314 may be performed by an electronic device. The electronic device may include a server or a terminal device. The server may be the server 105 in FIG. 1. The terminal device may be the terminal device 101, the terminal device 102 or the terminal device 103 in FIG. 1.

According to embodiments of the present disclosure, operation S314 may include the following operations.

The fourth intermediate feature data is processed based on an attention strategy, so as to obtain the first intermediate feature data.

According to embodiments of the present disclosure, the attention strategy may be implemented to focus on an important information with a large weight, ignore an unimportant information with a small weight, and exchange information with other information by sharing important information, so as to achieve a transmission of important information. In embodiments of the present disclosure, the attention strategy may be implemented to extract an information of the first category feature data, an information inside the image block to be identified, and an information between the first category feature data and the image block to be identified, so as to better process the image to be identified.

According to embodiments of the present disclosure, the fourth intermediate feature data may be processed based on the attention strategy to obtain the first intermediate feature data for indicating the global feature of the image to be identified. For example, an attention unit may be determined according to the attention strategy. The fourth intermediate feature data may be processed to obtain the first intermediate feature data by using the attention unit.

According to embodiments of the present disclosure, the first intermediate feature data is obtained by processing the fourth intermediate feature data based on the attention strategy. Therefore, the first intermediate feature data participates in a global self-attention mechanism and is coupled with a global information, so that the accuracy of the multi-task identification may be improved.

According to embodiments of the present disclosure, the first intermediate feature data may be obtained by processing the fourth intermediate feature data using an expected attention unit of the deep learning model.

According to embodiments of the present disclosure, the deep learning model may include a backbone module. The backbone module may include at least one backbone sub-module connected in cascade. The backbone sub-module may include an attention unit. The expected attention unit may be one of at least one attention unit. For example, the expected attention unit may be the attention unit included in the backbone sub-module of a first level. The respective object feature data of the plurality of image blocks to be identified and the first category feature data may be processed to obtain the first intermediate feature data by using the expected attention unit.

FIG. 4 schematically shows a flowchart of selecting a feature extraction strategy having a greatest matching degree with an image to be identified from a plurality of feature extraction strategies based on a target selection strategy and first intermediate feature data to obtain a target feature extraction strategy according to embodiments of the present disclosure.

As shown in FIG. 4, a method 400 is a further definition of operation S220 in FIG. 2, and the method 400 includes operations S421 to S422.

In operation S421, third intermediate feature data is obtained based on the target selection strategy and the first intermediate feature data.

In operation S422, a feature extraction strategy having a greatest matching degree with the image to be identified is selected from a plurality of feature extraction strategies according to the third intermediate feature data, so as to obtain a target feature extraction strategy.

According to embodiments of the present disclosure, the third intermediate feature data may include an information related to determining the target feature extraction strategy. For example, the third intermediate feature data may be an intermediate matrix. An element value of an element included in the intermediate matrix may indicate a probability that the feature extraction strategy is determined as the target feature extraction strategy.

According to embodiments of the present disclosure, target selection parameter data corresponding to the target selection strategy may be determined. The third intermediate feature data may be obtained according to the target selection parameter data and the first intermediate feature data. Then, the target feature extraction strategy corresponding to the image to be identified may be determined from the plurality of feature extraction strategies according to the information indicated by the third intermediate feature data. That is, the third intermediate feature data indicates the information of the target feature extraction strategy corresponding to the image to be identified among the plurality of feature extraction strategies, and the target feature extraction strategy corresponding to the image to be identified may be determined from the plurality of feature extraction strategies according to the information indicated by the third intermediate feature data.

According to embodiments of the present disclosure, operations S421 to S422 may be performed by an electronic device. The electronic device may be a server or a terminal device. The server may be the server 105 in FIG. 1. The terminal device may be the terminal device 101, the terminal device 102 or the terminal device 103 in FIG. 1.

According to embodiments of the present disclosure, operation S421 may include the following operations.

A target selection matrix is determined according to the target selection strategy. An intermediate matrix is determined according to the first intermediate feature data. A target expert probability matrix is determined according to the target selection matrix and the intermediate matrix. The target expert probability matrix includes elements respectively corresponding to each of the plurality of feature extraction strategies. The element value of an element indicates a probability that the feature extraction strategy is selected. The expert probability matrix is determined as the third intermediate feature data.

According to embodiments of the present disclosure, the target selection strategy may have a target selection matrix corresponding to the target selection strategy. The target selection matrix corresponding to the target selection strategy may be determined. The first intermediate feature data may be processed to obtain an intermediate matrix. Then a target expert probability matrix may be obtained according to the target selection matrix and the intermediate matrix. For example, the target selection matrix and the intermediate matrix may be weighted and multiplied to obtain the target expert probability matrix. Alternatively, the target selection matrix may be added to the intermediate matrix to obtain the target expert probability matrix. Alternatively, the target selection matrix may be subtracted from the intermediate matrix to obtain the target expert probability matrix.

According to embodiments of the present disclosure, determining the target expert probability matrix according to the target selection matrix and the intermediate matrix may include the following operations.

The target selection matrix is multiplied by the intermediate matrix to obtain the target expert probability matrix.

According to embodiments of the present disclosure, the first intermediate feature data may be processed to obtain an intermediate matrix that may be multiplied by the target selection matrix. After the target selection matrix and the intermediate matrix are obtained, the target selection matrix may be multiplied by the intermediate matrix to obtain the target expert probability matrix.

According to embodiments of the present disclosure, selecting the feature extraction strategy having the greatest matching degree with the image to be identified from the plurality of feature extraction strategies according to the third intermediate feature data to obtain a target feature extraction strategy may include the following operations.

An element having an element value equal to a limit value is determined from the target expert probability matrix to obtain a target element. The limit value includes a maximum value or a minimum value. The feature extraction strategy corresponding to the target element is determined as the target feature extraction strategy.

According to embodiments of the present disclosure, the target element having an element value equal to the limit value may be determined from the target expert probability matrix. The feature extraction strategy corresponding to the target element is determined as the target feature extraction strategy.

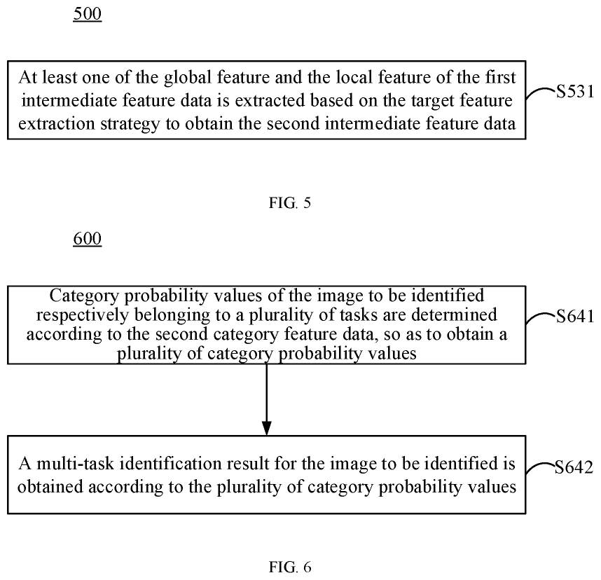

FIG. 5 schematically shows a flowchart of processing first intermediate feature data based on a target feature extraction strategy to obtain second intermediate feature data according to embodiments of the present disclosure.

As shown in FIG. 5, a method 500 is a further definition of operation S230 in FIG. 2, and the method 500 includes operation S531.

In operation S531, at least one of the global feature and the local feature of the first intermediate feature data is extracted based on the target feature extraction strategy to obtain the second intermediate feature data.

According to embodiments of the present disclosure, the first intermediate feature data may include first category feature data and respective first object feature data of a plurality of image blocks to be identified. The second intermediate feature data may include second category feature data and respective second object feature data of the plurality of image blocks to be identified.

According to embodiments of the present disclosure, at least one of the global feature and the local feature may be extracted from the first intermediate feature data based on the target feature extraction strategy to obtain the second intermediate feature data. That is, the global feature may be extracted from the first intermediate feature data based on the target feature extraction strategy to obtain the second intermediate feature data. Alternatively, the local feature may be extracted from the first intermediate feature data based on the target feature extraction strategy to obtain the second intermediate feature data. Alternatively, the global feature and the local feature may be extracted from the first intermediate feature data based on the target feature extraction strategy to obtain the second intermediate feature data.

According to embodiments of the present disclosure, the target feature extraction strategy may include at least one of a target attention strategy and a target local strategy. The target attention strategy may be used to extract an information of the first category feature data itself, an information inside the image block to be identified, and an information between the first category feature data and the image block to be identified, so as to better process the image to be identified. The target local strategy may be used to extract the information of the first category feature data itself and the information inside the image block to be identified.

According to embodiments of the present disclosure, the first intermediate feature data may be processed based on at least one of the target attention strategy and the target local strategy, so as to obtain the second intermediate feature data for indicating at least one of the global feature and the local feature of the image to be identified.

According to embodiments of the present disclosure, operation S531 may be performed by an electronic device. The electronic device may be a server or a terminal device. The server may be the server 105 in FIG. 1. The terminal device may be the terminal device 101, the terminal device 102 or the terminal device 103 in FIG. 1.

According to embodiments of the present disclosure, operation S531 may include the following operations.

At least one expert unit corresponding to the target feature extraction strategy is determined from a plurality of expert units included in the deep learning model to obtain at least one target expert unit. The expert unit includes at least one selected from: a multi-head self-attention layer or a feed-forward network layer. The first intermediate feature data s processed by using the at least one target expert unit, so as to obtain the second intermediate feature data.

According to embodiments of the present disclosure, the deep learning model may include a backbone module. The backbone module may include at least one backbone sub-module connected in cascade. The backbone sub-module may include a plurality of expert units. The expert unit may include at least one selected from: a multi-head self-attention (MHA) layer and a feed-forward network (FFN) layer. The backbone sub-module may be a Transformer-based model structure.

According to embodiments of the present disclosure, the target feature extraction strategy may have at least one target expert unit corresponding to the target feature extraction strategy. The first intermediate feature data may be processed by using the at least one target expert unit, so as to obtain the second intermediate feature data. The target expert unit may include one selected from: a target multi-head self-attention layer, a target feed-forward network layer, or a target multi-head self-attention layer and a target feed-forward network layer connected in cascade.

According to embodiments of the present disclosure, the backbone module may include M backbone sub-modules connected in cascade, and M may be an integer greater than or equal to 1.

According to embodiments of the present disclosure, the backbone sub-module may further include an expert selection unit.

According to embodiments of the present disclosure, processing the first intermediate feature data by using the at least one target expert unit so as to obtain the second intermediate feature data may include the following operations.

In the case of M=1, the first intermediate feature data is processed by using the target expert unit of a first level, so as to obtain fifth intermediate feature data of the first level. The second intermediate feature data is obtained according to the fifth intermediate feature data of the first level.

In a case of M>1 and m>1, sixth intermediate feature data of an m^{th} level is processed by using the target expert unit of the m^{th} level, so as to obtain the fifth intermediate feature data of the m^{th} level. The sixth intermediate feature data of the m^{th} level is obtained by processing the fifth intermediate feature data of an (m−1)^{th} level using the attention unit of the m^{th} level. The target expert unit of the m^{th} level is determined according to a result obtained by processing the fifth intermediate feature data of the (m−1)^{th} level using the expert selection unit of the m^{th} level. The second intermediate feature data is obtained according to the fifth intermediate sample feature data of an N^{th} level. N is an integer greater than or equal to 1 and less than M.

According to embodiments of the present disclosure, M may be an integer greater than or equal to 1. N may be an integer greater than 1 and less than or equal to M. The values of M and N may be configured according to actual service requirements, which are not limited here. For example, M=N=4. m∈{1, 2, . . . , (M−1), M}.

According to embodiments of the present disclosure, the target expert unit of the m^{th} level may be determined from a plurality of expert units of the m^{th} level according to the expert selection unit of the m^{th} level and the fifth intermediate feature data of the (m−1)^{th} level for the image to be identified.

According to embodiments of the present disclosure, when the target expert unit of the m^{th} level includes a multi-head self-attention layer, the sixth intermediate feature data of the m^{th} level is processed by the target multi-head self-attention layer of the m^{th} level to obtain the fifth intermediate feature data of the m^{th} level.

According to embodiments of the present disclosure, when the target expert unit of the m^{th} level includes a target feed forward network layer, the sixth intermediate feature data of the m^{th} level is processed by the target feed forward network layer of the m^{th} level to obtain the fifth intermediate feature data of the m^{th} level.

According to embodiments of the present disclosure, when the target expert unit of the m^{th} level includes a target multi-head self-attention layer and a target feed forward network layer, processing the sixth intermediate feature data of the m^{th} level by the target expert unit of the m^{th} level to obtain the fifth intermediate feature data of the m^{th} level may include the following operations.

The sixth intermediate feature data of the m^{th} level is processed by using the target multi-head self-attention layer of the m^{th} level to obtain seventh intermediate feature data of the m^{th} level. The seventh intermediate feature data of the m^{th} level is processed by the target feed forward network layer of the m^{th} level to obtain the fifth intermediate feature data of the m^{th} level.

According to embodiments of the present disclosure, the fifth intermediate feature data of the N^{th} level may be determined as the second intermediate feature data. N may be equal to M.

FIG. 6 schematically shows a flowchart of obtaining a multi-task identification result for an image to be identified according to second intermediate feature data according to embodiments of the present disclosure.

According to embodiments of the present disclosure, the second intermediate feature data may include second category feature data.

As shown in FIG. 6, a method 600 is a further definition of operation S240 in FIG. 2, and the method 600 includes operations S641 to S642.

In operation S641, category probability values of the image to be identified respectively belonging to a plurality of tasks are determined according to the second category feature data, so as to obtain a plurality of category probability values.

In operation S642, a multi-task identification result for the image to be identified is obtained according to the plurality of category probability values.

According to embodiments of the present disclosure, the category probability values of the image to be identified may refer to respective probability values of the image to be identified belonging to at least one category of a plurality of tasks. For example, when the image to be identified is a face image to be identified, and the task dimension includes a face identification, a body identification and a vehicle identification, the category probability values of the image to be identified may include a probability value of the face image to be identified belonging to at least one category related to the face identification, a probability value of the face image to be identified belonging to at least one category related to the body identification, and a probability value of the face image to be identified belonging to at least one category related to the vehicle identification.

According to embodiments of the present disclosure, the object feature data may be obtained by processing the image block to be identified using an object processing unit of the deep learning model.

According to embodiments of the present disclosure, the first category feature data may be obtained by processing predetermined data using a category processing unit of the deep learning model.

According to embodiments of the present disclosure, the deep learning model may include a preprocessing module. The preprocessing module may include an object processing unit and a category processing unit. The object processing unit may be used to process a plurality of image blocks to be identified included in the image to be identified, so as to obtain respective object feature data of the plurality of image blocks to be identified. The category processing unit may be used to process the predetermined data to obtain the first category feature data. Both the object processing unit and the category processing unit may include a network structure that may be used to perform a feature extraction. For example, the object processing unit may include a convolutional neural network. The category processing unit may include a convolutional neural network. The network structure of the object processing unit and the network structure of the category processing unit may be the same or different.

According to embodiments of the present disclosure, the plurality of category probability values may be obtained by processing the second category feature data included in the second intermediate feature data using a category classification module of the deep learning model.

According to embodiments of the present disclosure, the deep learning model may include a category classification module. The category classification module may be used to process the second category feature data to obtain a plurality of category probability values. The category classification module may include a network structure that may be used to perform a classification. For example, the category classification module may include one of a linear classifier and a non-linear classifier.

According to embodiments of the present disclosure, the second category feature data may be processed by the category classification module to obtain the category probability values of the image to be identified respectively belonging to the plurality of tasks, so as to obtain a plurality of category probability values.

According to embodiments of the present disclosure, operations S641 to S642 may be performed by an electronic device. The electronic device may be a server or a terminal device. The server may be the server 105 in FIG. 1. The terminal device may be the terminal device 101, the terminal device 102 or the terminal device 103 in FIG. 1.

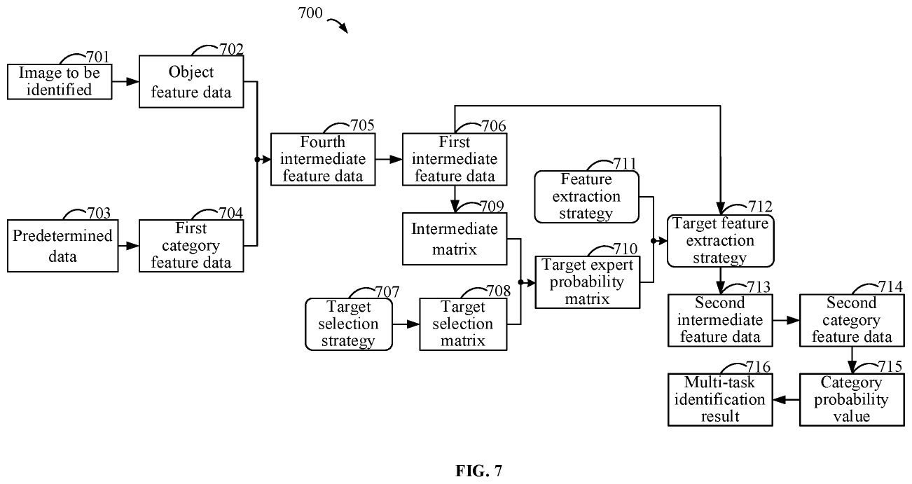

FIG. 7 schematically shows a schematic example diagram of a multi-task identification method according to embodiments of the present disclosure.

As shown in FIG. 7, in 700, an image to be identified 701 and predetermined data 703 may be acquired.

The image to be identified 701 is processed to obtain respective object feature data 702 of a plurality of image blocks to be identified contained in the image to be identified 701. The predetermined data 703 is processed to obtain first category feature data 704. Fourth intermediate feature data 705 is obtained according to the first category feature data 704 and the respective object feature data 702 of the plurality of image blocks to be identified. The fourth intermediate feature data 705 is processed based on an attention strategy, so as to obtain first intermediate feature data 706.

A target selection matrix 708 is determined according to a target selection strategy 707. An intermediate matrix 709 is determined according to the first intermediate feature data 706. A target expert probability matrix 710 is determined based on the target selection matrix 708 and the intermediate matrix 709. The target expert probability matrix 710 includes elements respectively corresponding to a plurality of feature extraction strategies 711. An element value of the element indicates a probability that the feature extraction strategy 711 is selected. An element having an element value equal to a limit value is determined from the target expert probability matrix 710, so as to obtain a target element. The feature extraction strategy corresponding to the target element is determined as a target feature extraction strategy 712.

At least one of a global feature and a local feature of the first intermediate feature data 706 may be extracted based on the target feature extraction strategy 712, so as to obtain second intermediate feature data 713. The second intermediate feature data 713 includes second category feature data 714. Category probability values 715 of the image to be identified 701 respectively belonging to a plurality of tasks may be determined according to the second category feature data 714, so as to obtain a plurality of category probability values 715. A multi-task identification result 716 for the image to be identified 701 may be obtained according to the plurality of category probability values 715.

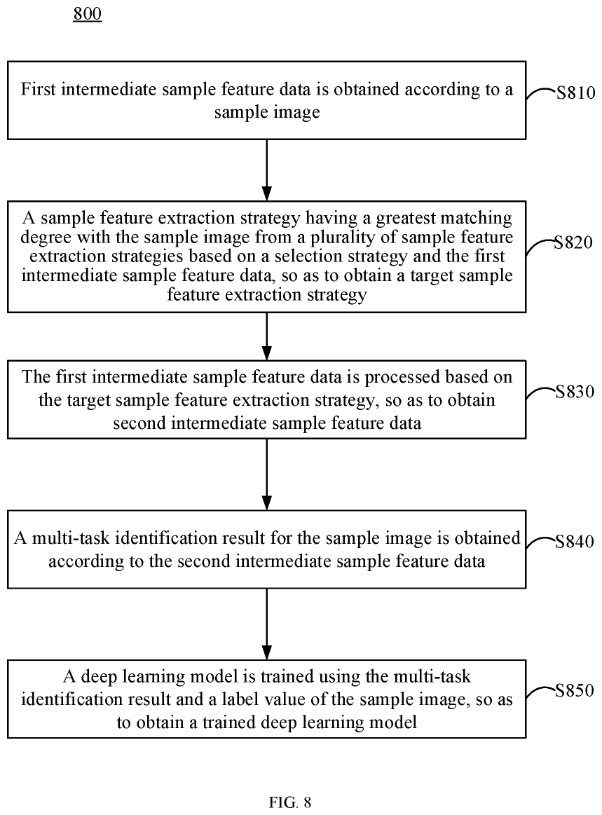

FIG. 8 schematically shows a flowchart of a method of training a deep learning model according to embodiments of the present disclosure.

As shown in FIG. 8, a method 800 includes operations S810 to S850.

In operation S810, first intermediate sample feature data is obtained according to a sample image.

In operation S820, a sample feature extraction strategy having a greatest matching degree with the sample image from a plurality of sample feature extraction strategies based on a selection strategy and the first intermediate sample feature data, so as to obtain a target sample feature extraction strategy.

In operation S830, the first intermediate sample feature data is processed based on the target sample feature extraction strategy, so as to obtain second intermediate sample feature data.

In operation S840, a multi-task identification result for the sample image is obtained according to the second intermediate sample feature data.

In operation S850, a deep learning model is trained using the multi-task identification result and a label value of the sample image, so as to obtain a trained deep learning model.

According to embodiments of the present disclosure, for descriptions of the sample image, the first intermediate sample feature data and the second intermediate sample feature data, reference may be made to relevant contents described above for the image to be identified, the first intermediate feature data and the second intermediate feature data, which will not be repeated here.

According to embodiments of the present disclosure, the deep learning model may include a preprocessing module, a backbone module, and a category classification module.

According to embodiments of the present disclosure, the deep learning model may be trained based on a loss function by using the multi-task identification result and the label value of the sample image, so as to obtain a trained deep learning model. The trained deep learning model may be used to perform a multi-task identification. The loss function may be configured according to actual service requirements, which is not limited here. For example, the loss function may include at least one selected from: a cross-entropy loss function, an exponential loss function, or a square loss function. A predetermined condition may include at least one selected from a convergence of an output value or reaching a maximum number of training rounds.

According to embodiments of the present disclosure, operations S810 to S850 may be performed by an electronic device. The electronic device may be a server or a terminal device. The server may be the server 105 in FIG. 1. The terminal device may be the terminal device 101, the terminal device 102 or the terminal device 103 in FIG. 1.

According to embodiments of the present disclosure, the sample image has a target sample feature extraction strategy corresponding to the sample image, and different sample images may have the same or different target sample feature extraction strategies, so that the target sample feature extraction strategy may be selected dynamically for the sample image, and a coupling degree of sample feature extraction strategies between different sample images may be reduced. On this basis, since the target sample feature extraction strategy has the greatest matching degree with the sample image, a conflict between different tasks on a model parameter update may be reduced by training the deep learning model using the multi-mask identification result obtained by processing the first intermediate sample feature data based on the target sample feature extraction strategy, so that a multi-task identification accuracy of the multi-task identification model may be improved.

According to embodiments of the present disclosure, operation S820 may include the following operations.

Third intermediate sample feature data is obtained based on the selection strategy and the first intermediate sample feature data. A sample feature extraction strategy having a greatest matching degree with the sample image is selected from a plurality of sample feature extraction strategies according to the third intermediate sample feature data, so as to obtain a target sample feature extraction strategy.

According to embodiments of the present disclosure, obtaining the third intermediate sample feature data based on the selection strategy and the first intermediate sample feature data may include the following operations.

A selection matrix is determined according to the selection strategy. An intermediate sample matrix is determined according to the first intermediate sample feature data. A sample expert probability matrix is determined according to the selection matrix and the intermediate sample matrix. The sample expert probability matrix includes sample elements respectively corresponding to the plurality of sample feature extraction strategies. An element value of the sample element indicates a probability that the sample feature extraction strategy is selected. The sample expert probability matrix is determined as the third intermediate sample feature data.

According to embodiments of the present disclosure, determining the sample expert probability matrix according to the selection matrix and the intermediate sample matrix may include the following operations.

The selection matrix is multiplied by the intermediate sample matrix to obtain the sample expert probability matrix.

According to embodiments of the present disclosure, selecting the sample feature extraction strategy having the greatest matching degree with the sample image from the plurality of sample feature extraction strategies according to the third intermediate sample feature data so as to obtain the target sample feature extraction strategy may include the following operations.

A sample element having a sample element value equal to a limit value is determined from the sample expert probability matrix, so as to obtain a target sample element. The limit value includes a maximum value or a minimum value. The sample feature extraction strategy corresponding to the target sample element is determined as the target sample feature extraction strategy.

According to embodiments of the present disclosure, operation S810 may include the following operations.

The sample image is processed to obtain respective sample object feature data of a plurality of sample image blocks. The predetermined sample data is processed to obtain first sample category feature data. Fourth intermediate sample feature data is obtained according to the respective sample object feature data of the plurality of sample image blocks and the first sample category feature data. The fourth intermediate sample feature data is processed to obtain the first intermediate sample feature data.

According to embodiments of the present disclosure, processing the fourth intermediate sample feature data to obtain the first intermediate sample feature data may include the following operations.

The fourth intermediate sample feature data is processed based on an attention strategy, so as to obtain the first intermediate sample feature data.

According to embodiments of the present disclosure, the deep learning model may include a backbone module. The backbone module may include at least one backbone sub-module connected in cascade. The backbone sub-module may include an attention unit.

According to embodiments of the present disclosure, processing the fourth intermediate sample feature data based on the attention strategy to obtain the first intermediate sample feature data may include the following operations.

The fourth intermediate sample feature data is processed by using an expected attention unit in the backbone module, so as to obtain the first intermediate sample feature data.

According to embodiments of the present disclosure, processing the first intermediate sample feature data based on the target sample feature extraction strategy so as to obtain the second intermediate sample feature data may include the following operations.

At least one of a global feature and a local feature of the first intermediate sample feature data is extracted based on the target sample feature extraction strategy, so as to obtain the second intermediate sample feature data.

According to embodiments of the present disclosure, the backbone sub-module may further include a plurality of expert units. The expert unit may include at least one selected from a multi-head self-attention layer and a feed forward network layer.

According to embodiments of the present disclosure, extracting at least one of the global feature and the local feature of the first intermediate sample feature data based on the target sample feature extraction strategy so as to obtain the second intermediate sample feature data may include the following operations.

At least one expert unit corresponding to the target sample feature extraction strategy is determined from the plurality of expert units to obtain at least one target sample expert unit. The first intermediate sample feature data is processed by using the at least one target sample expert unit, so as to obtain the second intermediate sample feature data.

According to embodiments of the present disclosure, the backbone module may include M backbone sub-modules connected in cascade. M is an integer greater than or equal to 1.

According to embodiments of the present disclosure, the backbone sub-module may further include an expert selection unit.

According to embodiments of the present disclosure, processing the first intermediate sample feature data by using the at least one target sample expert unit so as to obtain the second intermediate sample feature data may include the following operations.

In a case of M=1, the first intermediate sample feature data is processed by using the target sample expert unit of a first level, so as to obtain fifth intermediate sample feature data of the first level. The second intermediate sample feature data is obtained according to the fifth intermediate sample feature data of the first level.

In a case of M>1 and m>1, sixth intermediate sample feature data of an m^{th} level is processed by using the target sample expert unit of the m^{th} level, so as to obtain the fifth intermediate sample feature data of the m^{th} level. The sixth intermediate sample feature data of the m^{th} level is obtained by processing the fifth intermediate sample feature data of an (m−1)th level using the attention unit of the m^{th} level. The target sample expert unit of the m^{th} level is determined according to a result obtained by processing the fifth intermediate sample feature data of the (m−1)^{th} level using the expert selection unit of the m^{th} level. The second intermediate sample feature data is obtained according to the fifth intermediate sample feature data of an N^{th} level. N is an integer greater than or equal to 1 and less than M.

According to embodiments of the present disclosure, the target sample expert unit may include a target multi-head self-attention layer and a target feed forward network layer.

According to embodiments of the present disclosure, processing the sixth intermediate sample feature data of the m^{th} level by using the target sample expert unit of the m^{th} level so as to obtain the fifth intermediate sample feature data of the m^{th} level may include the following operations.

The sixth intermediate sample feature data of the m^{th} level is processed by using the target multi-head self-attention layer of the m^{th} level, so as to obtain seventh intermediate sample feature data of the m^{th} level. The seventh intermediate sample feature data of the m^{th} level is processed by using the target feed forward network layer of the m^{th} level, so as to obtain the fifth intermediate sample feature data of the m^{th} level.

According to embodiments of the present disclosure, the sample image has a target sample expert unit corresponding to the sample image, and different sample images may have the same or different target sample expert units. Therefore, the target sample expert unit may be dynamically selected for the sample image, so that a coupling degree of the backbone module is reduced. On this basis, since the target sample expert unit has the greatest matching degree with the sample image, a conflict between different tasks on a model parameter update may be reduced by training the deep learning model using the multi-mask identification result obtained by processing the first intermediate sample feature data based on the target sample expert unit, so that a multi-task identification accuracy of the multi-task identification model may be improved.

According to embodiments of the present disclosure, the second intermediate sample feature data may include second sample category feature data.

According to embodiments of the present disclosure, obtaining the multi-task identification result for the sample image according to the second intermediate sample feature data may include the following operations.

Category probability values of the sample image respectively belonging to a plurality of tasks are determined according to the second sample category feature data, so as to obtain a plurality of sample category probability values. The multi-task identification result for the sample image is obtained according to the plurality of sample category probability values.

According to embodiments of the present disclosure, the deep learning model may include a category classification module.

According to embodiments of the present disclosure, determining the category probability values of the sample image respectively belonging to the plurality of tasks according to the second sample category feature data so as to obtain a plurality of sample category probability values may include the following operations.

The second sample category feature data is processed by using the category classification module to determine the category probability values of the sample image respectively belonging to the plurality of tasks, so as obtain a plurality of sample category probability values.

According to embodiments of the present disclosure, the plurality of sample category probability values and a label value may be input into a loss function to obtain an output value. A model parameter of the deep learning model may be adjusted according to the output value until a predetermined end condition is met. The deep learning model obtained when the predetermined end condition is met may be determined as the trained deep learning model. The predetermined end condition may include at least one selected from a convergence of the output value and reaching a maximum number of training rounds. For example, the model parameter of the deep learning model may be adjusted according to a back-propagation algorithm or a stochastic gradient descent algorithm until the predetermined end condition is met.

According to embodiments of the present disclosure, the loss function may be determined according to Equation (1).

Lⱼ=Σᵢ₌₁^{B}Σₖ₌₁^{C}^{ⱼ}yᵢⱼ[zᵢⱼₖ log pᵢⱼₖ+(1−zᵢⱼₖ)log(1−pᵢⱼₖ)] (1)

According to embodiments of the present disclosure, Lⱼ represents a loss function, B represents a number of sample images included in each batch, and B may be an integer greater than 1. T represents a number of tasks, and T may be a number greater than 1. Cⱼ represents a number of categories included in a j^{th} task, and Cⱼ may be an integer greater than or equal to 1. yᵢⱼ represents a task label value of the j^{th} task for an i^{th} sample image, that is, yᵢⱼ indicates whether the i^{th} sample image belongs to the j^{th} task. yᵢⱼ=1 indicates that the i^{th} sample image belongs to the j^{th} task. yᵢⱼ=0 indicates that the i^{th} sample image does not belong to the j^{th} task. zᵢⱼₖ represents a category label value of a k^{th} category of the i^{th} task for the i^{th} sample image, that is, zᵢⱼₖ indicates whether the i^{th} sample image belongs to the k^{th} category of the j^{th} task. zᵢⱼₖ=1 indicates that the i^{th} sample image belongs to the k^{th} category of the j^{th} task. zᵢⱼₖ=0 indicates that the i^{th} sample image does not belong to the k^{th} category of the j^{th} task.

According to embodiments of the present disclosure, the deep learning model may include a preprocessing module. The preprocessing module may include an object processing unit and a category processing unit.

According to embodiments of the present disclosure, the sample object feature data is obtained by processing the sample image block using the object processing unit.

According to embodiments of the present disclosure, the first sample category feature data is obtained by processing the predetermined sample data using the category processing unit.

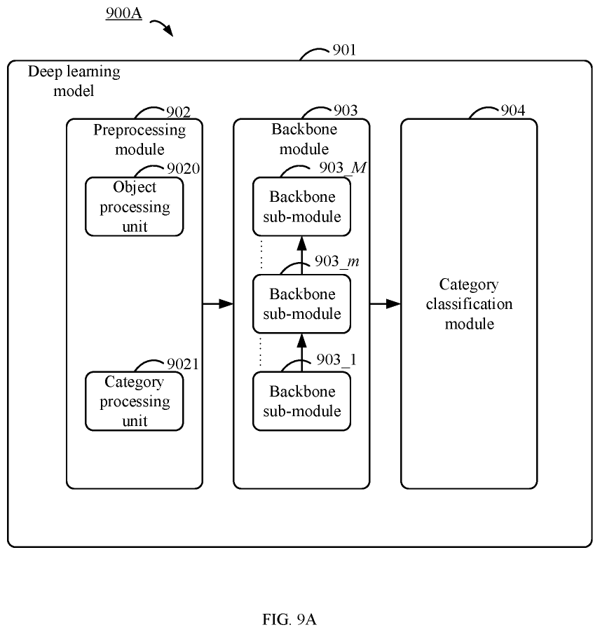

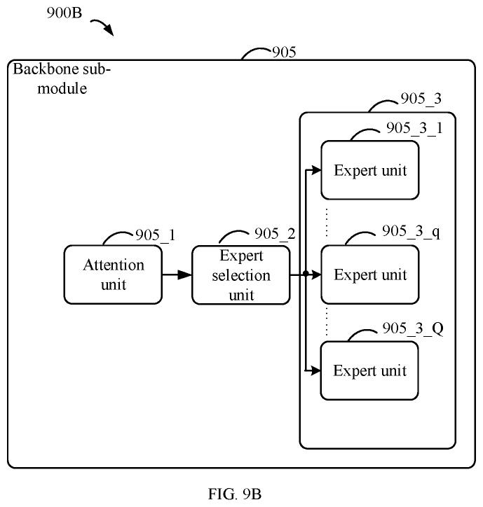

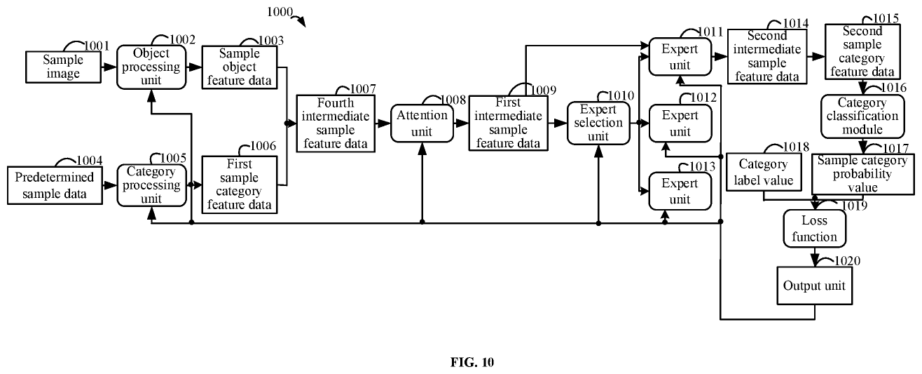

The method of training the deep learning model according to embodiments of the present disclosure will be further described below with reference to FIG. 9A, FIG. 9B and FIG. 10 in conjunction with specific embodiments.

FIG. 9A schematically shows a schematic example diagram of a deep learning model according to embodiments of the present disclosure.

As shown in FIG. 9A, in 900A, a deep learning model 901 includes a preprocessing module 902, a backbone module 903, and a category classification module 904.

The preprocessing module 902 may include an object processing unit 9020 and a category processing unit 9021.

The backbone module 903 may include M backbone sub-modules connected in cascade, that is, a backbone sub-modules 903_1, . . . , a backbone sub-modules 903_m, . . . , a backbone sub-modules 903_M. M may be an integer greater than or equal to 1.

FIG. 9B schematically shows a schematic example diagram of a backbone sub-module according to embodiments of the present disclosure.

As shown in FIG. 9B, in 900B, a backbone sub-module 905 includes an attention unit 905_1, an expert selection unit 905_2, and a set of expert units 905_3. The set of expert units 905_3 includes Q expert units, namely, an expert unit 905_3_1, . . . , an expert unit 905_3_q, . . . , an expert units 905_3_Q. Q may be an integer greater than 1. The attention unit 905_3_1 may be a multi-head self-attention unit. The expert selection unit 905_3_2 may be a selection matrix of updatable element values. The expert unit 905_3_q may include: a multi-head self-attention layer, a feed forward network layer, and a multi-head self-attention layer and a feed forward network layer connected in cascade. An output of the multi-head self-attention layer in the multi-head self-attention layer and the feed forward network layer connected in cascade is used as an input to the feed forward network layer.

FIG. 10 schematically shows a schematic diagram of a method of training a deep learning model according to embodiments of the present disclosure.

As shown in FIG. 10, in 1000, the deep learning model includes a preprocessing module, a backbone module, and a category classification module 1016. The preprocessing module includes an object processing unit 1002 and a category processing unit 1005. The backbone module includes an attention unit 1008, an expert unit 1010 and three expert units. The three expert units include an expert unit 1011, an expert unit 1012, and an expert unit 1013. The backbone module may include Transformer.

A sample image 1001 is processed by the object processing unit 1002 to obtain respective sample object feature data 1003 of a plurality of sample image blocks contained in the sample image 1001. Predetermined sample data 1004 is processed by the category processing unit 1005 to obtain first sample category feature data 1006. Fourth intermediate sample feature data 1007 may be obtained according to the first sample category feature data 1006 and the respective sample object feature data 1003 of the plurality of sample image blocks. Dimensions of the fourth intermediate sample feature data 1007 may be (b, t+1, d), where b represents the number of sample images included in a current batch, t represents the number of objects included in the current batch, and d represents a feature dimension of each object.

The fourth intermediate sample feature data 1007 may be processed by using the attention unit 1008, so as to obtain first intermediate sample feature data 1009. Dimensions of the first intermediate sample feature data 1009 may be (b, t+1, d).

An intermediate sample matrix may be determined according to the first intermediate sample feature data 1009. That is, last two dimensions of the first intermediate sample feature data 1009 may be combined to obtain an intermediate sample matrix with dimensions (b, td+d). The intermediate sample matrix may be processed by using an expert selection unit 1010 to obtain an expert sample probability matrix. The expert selection unit 1010 may be a matrix of updatable element values with dimensions (td+d, Q=3). Dimensions of the expert sample probability matrix may be (b, Q=3). A sample element having a sample element value equal to a limit value may be determined from the sample expert probability matrix, so as obtain a target sample element. The expert selection unit 1011 corresponding to the target sample element is determined as a target sample expert unit.

The first intermediate sample feature data 1009 may be processed by using the target sample expert unit (i.e., the expert unit 1011), so as to obtain second intermediate sample feature data 1014. The second intermediate sample feature data 1014 includes second category sample feature data 1015.

The second sample category feature data 1015 may be processed by using the category classification module 1016 to obtain a sample category probability value 1017. An output value 1020 may be obtained based on a loss function 1019 by using the sample category probability value 1017 and a category label value 1018.

Model parameters of the object processing unit 1002, the category processing unit 1005, the attention unit 1008, the expert selection unit 1010, the expert unit 1011, the expert unit 1012, the expert unit 1013 and the category classification module 1016 may be adjusted according to the output value 1020 until a predetermined end condition is met, so as to obtain a trained deep learning model.

In the technical solutions of the present disclosure, a collection, a storage, a use, a processing, a transmission, a provision, a disclosure, and an application of user personal information involved comply with provisions of relevant laws and regulations, take essential confidentiality measures, and do not violate public order and good custom. In the technical solution of the present disclosure, authorization or consent is obtained from the user before the user's personal information is obtained or collected.

The above are merely exemplary embodiments. However, the present disclosure is not limited thereto, and may further include other multi-task identification methods and methods of training a deep learning model known in the art, as long as the accuracy of multi-task identification may be improved.

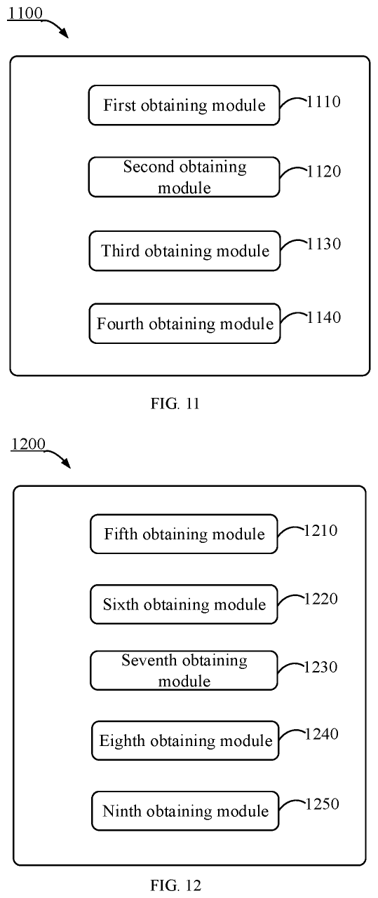

FIG. 11 schematically shows a block diagram of a multi-task identification apparatus according to embodiments of the present disclosure.

As shown in FIG. 11, a multi-task identification apparatus 1100 may include a first obtaining module 710, a second obtaining module 1120, a third obtaining module 1130, and a fourth obtaining module 1140.

The first obtaining module 1110 may be used to obtain first intermediate feature data according to an image to be identified.

The second obtaining module 1120 may be used to select a feature extraction strategy having a greatest matching degree with the image to be identified from a plurality of feature extraction strategies based on a target selection strategy and the first intermediate feature data, so as to obtain a target feature extraction strategy.

The third obtaining module 1130 may be used to process the first intermediate feature data based on the target feature extraction strategy, so as to obtain second intermediate feature data.

The fourth obtaining module 1140 may be used to obtain a multi-task identification result for the image to be identified according to the second intermediate feature data.

According to embodiments of the present disclosure, the second obtaining module 1120 may include a first obtaining sub-module and a second obtaining sub-module.

The first obtaining sub-module may be used to obtain third intermediate feature data based on the target selection strategy and the first intermediate feature data.

The second obtaining sub-module may be used to select the feature extraction strategy having the greatest matching degree with the image to be identified from the plurality of feature extraction strategies according to the third intermediate feature data, so as to obtain the target feature extraction strategy.

According to embodiments of the present disclosure, the first obtaining sub-module may include a first determination unit, a second determination unit, a third determination unit, and a fourth determination unit.

The first determination unit may be used to determine a target selection matrix according to the target selection strategy.

The second determination unit may be used to determine an intermediate matrix according to the first intermediate feature data.

The third determination unit may be used to determine a target expert probability matrix according to the target selection matrix and the intermediate matrix. The target expert probability matrix includes elements respectively corresponding to the plurality of feature extraction strategies, and an element value of the element indicates a probability that the feature extraction strategy is selected.

The fourth determination unit may be used to determine the target expert probability matrix as the third intermediate feature data.

According to embodiments of the present disclosure, the third determination unit may include a first obtaining sub-unit.

The first obtaining sub-unit may be used to multiply the target selection matrix by the intermediate matrix to obtain the target expert probability matrix.

According to embodiments of the present disclosure, the second obtaining sub-module may include a first obtaining unit and a fifth obtaining unit.

The first obtaining unit may be used to determine an element having an element value equal to a limit value from the target expert probability matrix to obtain a target element. The limit value includes a maximum value or a minimum value.

The fifth obtaining unit may be used to determine the feature extraction strategy corresponding to the target element as the target feature extraction strategy.

According to embodiments of the present disclosure, the first obtaining module 1110 may include a third obtaining sub-module, a fourth obtaining sub-module, a fifth obtaining sub-module, and a sixth obtaining sub-module.

The third obtaining sub-module may be used to process the image to be identified to obtain respective object feature data of a plurality of image blocks to be identified.

The fourth obtaining sub-module may be used to process predetermined data to obtain first category feature data.

The fifth obtaining sub-module may be used to obtain fourth intermediate feature data according to the respective object feature data of the plurality of image blocks to be identified and the first category feature data.

The sixth obtaining sub-module may be used to process the fourth intermediate feature data to obtain the first intermediate feature data.

According to embodiments of the present disclosure, the sixth obtaining sub-module may include a second obtaining unit.

The second obtaining unit may be used to process the fourth intermediate feature data based on an attention strategy, so as to obtain the first intermediate feature data.

According to embodiments of the present disclosure, the first intermediate feature data is obtained by processing the fourth intermediate feature data using an expected attention unit of a deep learning model.

According to embodiments of the present disclosure, the third obtaining module 1130 may include a seventh obtaining sub-module.

The seventh obtaining sub-module may be used to extract at least one of a global feature and a local feature of the first intermediate feature data based on the target feature extraction strategy, so as to obtain the second intermediate feature data.

According to embodiments of the present disclosure, the seventh obtaining sub-module may include a third obtaining unit and a fourth obtaining unit.

The third obtaining unit may be used to determine at least one expert unit corresponding to the target feature extraction strategy from a plurality of expert units contained in a deep learning model, so as to obtain at least one target expert unit. The expert unit includes at least one selected from a multi-head self-attention layer or a feed forward network layer.

The fourth obtaining unit may be used to process the first intermediate feature data by using the at least one target expert unit, so as to obtain the second intermediate feature data.

According to embodiments of the present disclosure, the second intermediate feature data includes second category feature data.

According to embodiments of the present disclosure, the fourth obtaining module 1140 may include an eighth obtaining sub-module and a ninth obtaining sub-module.

The eighth obtaining sub-module may be used to determine, according to the second category feature data, category probability values of the image to be identified respectively belonging to a plurality of tasks, so as to obtain a plurality of category probability values.

The ninth obtaining sub-module may be used to obtain the multi-task identification result for the image to be identified according to the plurality of category probability values.

FIG. 12 schematically shows a block diagram of an apparatus of training a deep learning model according to embodiments of the present disclosure.

As shown in FIG. 12, an apparatus 1200 of training a deep learning model may include a fifth obtaining module 1210, a sixth obtaining module 1220, a seventh obtaining module 1230, an eighth obtaining module 1240, and a ninth obtaining module 1250.

The fifth obtaining module 1210 may be used to obtain first intermediate sample feature data according to a sample image.

The sixth obtaining module 1220 may be used to select a sample feature extraction strategy having a greatest matching degree with the sample image from a plurality of sample feature extraction strategies based on a selection strategy and the first intermediate sample feature data, so as to obtain a target sample feature extraction strategy.

The seventh obtaining module 1230 may be used to process the first intermediate sample feature data based on the target sample feature extraction strategy, so as to obtain second intermediate sample feature data.

The eighth obtaining module 1240 may be used to obtain a multi-task identification result for the sample image according to the second intermediate sample feature data.

The ninth obtaining module 1250 may be used to train the deep learning model by using the multi-task identification result for the sample image and a label value of the sample image, so as to obtain a trained deep learning model.

According to embodiments of the present disclosure, the sixth obtaining module 1220 may include a tenth obtaining sub-module and an eleventh obtaining sub-module.

The tenth obtaining sub-module may be used to obtain third intermediate sample feature data based on the selection strategy and the first intermediate sample feature data.

The eleventh obtaining sub-module may be used to select the sample feature extraction strategy having the greatest matching degree with the sample image from the plurality of sample feature extraction strategies according to the third intermediate sample feature data, so as to obtain the target sample feature extraction strategy.

According to embodiments of the present disclosure, the tenth obtaining sub-module may include a sixth determination unit, a seventh determination unit, an eighth determination unit, and a ninth determination unit.

The sixth determination unit may be used to determine a selection matrix according to the selection strategy.

The seventh determination unit may be used to determine an intermediate sample matrix according to the first intermediate sample feature data.

The eighth determination unit may be used to determine a sample expert probability matrix according to the selection matrix and the intermediate sample matrix. The sample expert probability matrix includes sample elements respectively corresponding to the plurality of sample feature extraction strategies, and an element value of the sample element indicates a probability that the sample feature extraction strategy is selected.

The ninth determination unit may be used to determine the sample expert probability matrix as the third intermediate sample feature data.

According to embodiments of the present disclosure, the eighth determination unit may include a second obtaining sub-unit.

The second obtaining sub-unit may be used to multiply the selection matrix by the intermediate sample matrix to obtain the sample expert probability matrix.

According to embodiments of the present disclosure, the eleventh obtaining sub-module may include a fifth obtaining unit and a tenth determination unit.

The fifth obtaining unit may be used to determine a sample element having a sample element value equal to a limit value from the sample expert probability matrix, so as to obtain a target sample element. The limit value includes a maximum value or a minimum value.

The tenth determination unit may be used to determine a sample feature extraction strategy corresponding to the target sample element as the target sample feature extraction strategy.

According to embodiments of the present disclosure, the fifth obtaining module 1210 may include a twelfth obtaining sub-module, a thirteenth obtaining sub-module, a fourteenth obtaining sub-module, and a fifteenth obtaining sub-module.

The twelfth obtaining sub-module may be used to process the sample image to obtain respective sample object feature data of a plurality of sample image blocks.

The thirteenth obtaining sub-module may be used to process predetermined sample data to obtain first sample category feature data.

The fourteenth obtaining sub-module may be used to obtain fourth intermediate sample feature data according to the respective sample object feature data of the plurality of sample image blocks and the first sample category feature data.

The fifteenth obtaining sub-module may be used to process the fourth intermediate sample feature data to obtain the first intermediate sample feature data.

According to embodiments of the present disclosure, the fifteenth obtaining sub-module may include a sixth obtaining unit.

The sixth obtaining unit may be used to process the fourth intermediate sample feature data based on an attention strategy, so as to obtain the first intermediate sample feature data.

According to embodiments of the present disclosure, the deep learning model includes a backbone module, the backbone module includes at least one backbone sub-module connected in cascade, and the backbone sub-module includes an attention unit.

According to embodiments of the present disclosure, the sixth obtaining unit may include a third obtaining sub-unit.

The third obtaining sub-unit may be used to process the fourth intermediate sample feature data by using an expected attention unit in the backbone module, so as to obtain the first intermediate sample feature data.

According to embodiments of the present disclosure, the seventh obtaining module 1230 may include a sixteenth obtaining sub-module.

The sixteenth obtaining sub-module may be used to extract at least one of a global feature and a local feature of the first intermediate sample feature data based on the target sample feature extraction strategy, so as to obtain the second intermediate sample feature data.

According to embodiments of the present disclosure, the backbone sub-module further includes a plurality of expert units, and the expert unit includes at least one selected from a multi-head self-attention layer or a feed forward network layer.

According to embodiments of the present disclosure, the sixteenth obtaining sub-module may include a seventh obtaining unit and an eighth obtaining unit.

The seventh obtaining unit may be used to determine at least one expert unit corresponding to the target sample feature extraction strategy from the plurality of expert units, so as to obtain at least one target sample expert unit.

The eighth obtaining unit may be used to process the first intermediate sample feature data by using the at least one target sample expert unit, so as to obtain the second intermediate sample feature data.

According to embodiments of the present disclosure, the backbone module includes M backbone sub-modules connected in cascade, where M is an integer greater than or equal to 1.

According to embodiments of the present disclosure, the backbone sub-module further includes an expert selection unit.

According to embodiments of the present disclosure, the eighth obtaining unit may include a fourth obtaining sub-unit, a fifth obtaining sub-unit, a sixth obtaining sub-unit, and a seventh obtaining sub-unit.

For M=1,

the fourth obtaining sub-unit may be used to process the first intermediate sample feature data by using the target sample expert unit of a first level, so as to obtain fifth intermediate sample feature data of the first level; and

the fifth obtaining sub-unit may be used to obtain the second intermediate sample feature data according to the fifth intermediate sample feature data of the first level.

For M>1 and m>1,

the sixth obtaining sub-unit may be used to process sixth intermediate sample feature data of an m^{th} level by using the target sample expert unit of the m^{th} level, so as to obtain fifth intermediate sample feature data of the m^{th} level, the sixth intermediate sample feature data of the m^{th} level is obtained by processing the fifth intermediate sample feature data of an (m−1)^{th} level using an attention unit of the m^{th} level, and the target sample expert unit of the m^{th} level is determined according to a result obtained by processing the fifth intermediate sample feature data of the (m−1)^{th} level using an expert selection unit of the m^{th} level; and

the seventh obtaining sub-unit may be used to obtain the second intermediate sample feature data according to the fifth intermediate sample feature data of an N^{th} level, where N is an integer greater than or equal to 1 and less than M.

According to embodiments of the present disclosure, the target sample expert unit includes a target multi-head self-attention layer and a target feed forward network layer.

According to embodiments of the present disclosure, the sixth obtaining sub-unit may be further used to: process the sixth intermediate sample feature data of the m^{th} level by using the target multi-head self-attention layer of the m^{th} level, so as to obtain seventh intermediate sample feature data of the m^{th} level; and process the seventh intermediate sample feature data of the m^{th} level by using the target feed forward network layer of the m^{th} level, so as to obtain the fifth intermediate sample feature data of the m^{th} level.

According to embodiments of the present disclosure, the second intermediate sample feature data includes second sample category feature data.

According to embodiments of the present disclosure, the eighth obtaining module includes a determination sub-module and a seventh obtaining sub-module.

The determination sub-module may be used to determine, according to the second sample category feature data, category probability values of the sample image respectively belonging to a plurality of tasks, so as to obtain a plurality of sample category probability values.

The seventh obtaining sub-module may be used to obtain the multi-task identification result for the sample image according to the plurality of sample category probability values.

According to embodiments of the present disclosure, the deep learning model includes a category classification module.

According to embodiments of the present disclosure, the determination sub-module may include a ninth obtaining unit.

The ninth obtaining unit may be used to process the second sample category feature data and determine the category probability values of the sample image respectively belonging to the plurality of tasks by using the category classification module, so as to obtain the plurality of sample category probability values.

According to embodiments of the present disclosure, the deep learning model includes a preprocessing module, and the preprocessing module includes an object processing unit and a category processing unit.

According to embodiments of the present disclosure, the sample object feature data is obtained by processing the sample image block using the object processing unit.

According to embodiments of the present disclosure, the first sample category feature data is obtained by processing the predetermined sample data using the category processing unit.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the methods described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program, when executed by a processor, causes the processor to implement the methods described above.

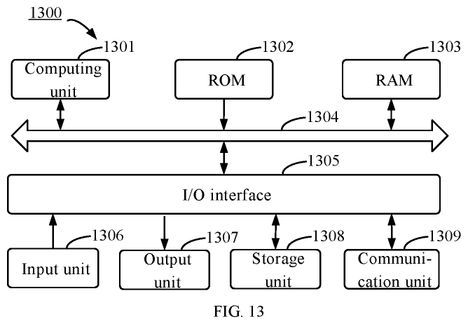

FIG. 13 schematically shows a block diagram of an electronic device suitable for implementing the multi-task identification method and the method of training the deep learning model of embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 13, the electronic device 1300 includes a computing unit 1301 which may perform various appropriate actions and processes according to a computer program stored in a read only memory (ROM) 1302 or a computer program loaded from a storage unit 1308 into a random access memory (RAM) 1303. In the RAM 1303, various programs and data necessary for an operation of the electronic device 1300 may also be stored. The computing unit 1301, the ROM 1302 and the RAM 1303 are connected to each other through a bus 1304. An input/output (I/O) interface 1305 is also connected to the bus 1304.

A plurality of components in the electronic device 1300 are connected to the I/O interface 1305, including: an input unit 1306, such as a keyboard, or a mouse; an output unit 1307, such as displays or speakers of various types; a storage unit 1308, such as a disk, or an optical disc; and a communication unit 1309, such as a network card, a modem, or a wireless communication transceiver. The communication unit 1309 allows the electronic device 1300 to exchange information/data with other devices through a computer network such as Internet and/or various telecommunication networks.

The computing unit 1301 may be various general-purpose and/or dedicated processing assemblies having processing and computing capabilities. Some examples of the computing units 1301 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1301 executes various methods and steps described above, such as the multi-task identification method and the method of training the deep learning model. For example, in some embodiments, the multi-task identification method and the method of training the deep learning model may be implemented as a computer software program which is tangibly embodied in a machine-readable medium, such as the storage unit 1308. In some embodiments, the computer program may be partially or entirely loaded and/or installed in the electronic device 1300 via the ROM 1302 and/or the communication unit 1309. The computer program, when loaded in the RAM 1303 and executed by the computing unit 1301, may execute one or more steps in the multi-task identification method and the method of training the deep learning model described above. Alternatively, in other embodiments, the computing unit 1301 may be used to perform the multi-task identification method and the method of training the deep learning model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A multi-task identification method, comprising:
obtaining first intermediate feature data according to an image to be identified;
selecting a feature extraction strategy having a greatest matching degree with the image to be identified from a plurality of feature extraction strategies based on a target selection strategy and the first intermediate feature data, so as to obtain a target feature extraction strategy;
processing the first intermediate feature data based on the target feature extraction strategy, so as to obtain second intermediate feature data; and
obtaining a multi-task identification result for the image to be identified according to the second intermediate feature data.

2. The method according to claim 1, wherein the selecting a feature extraction strategy having a greatest matching degree with the image to be identified from a plurality of feature extraction strategies based on a target selection strategy and the first intermediate feature data, so as to obtain a target feature extraction strategy comprises:
obtaining third intermediate feature data based on the target selection strategy and the first intermediate feature data; and
selecting the feature extraction strategy having the greatest matching degree with the image to be identified from the plurality of feature extraction strategies according to the third intermediate feature data, so as to obtain the target feature extraction strategy.

3. The method according to claim 2, wherein the obtaining third intermediate feature data based on the target selection strategy and the first intermediate feature data comprises:
determining a target selection matrix according to the target selection strategy;
determining an intermediate matrix according to the first intermediate feature data;
determining a target expert probability matrix according to the target selection matrix and the intermediate matrix, wherein the target expert probability matrix comprises elements respectively corresponding to the plurality of feature extraction strategies, and an element value of the element indicates a probability that the feature extraction strategy is selected; and
determining the target expert probability matrix as the third intermediate feature data.

4. The method according to claim 3, wherein the determining a target expert probability matrix according to the target selection matrix and the intermediate matrix comprises:
multiplying the target selection matrix by the intermediate matrix to obtain the target expert probability matrix.

5. The method according to claim 3, wherein the selecting the feature extraction strategy having the greatest matching degree with the image to be identified from the plurality of feature extraction strategies according to the third intermediate feature data, so as to obtain the target feature extraction strategy comprises:
determining an element having an element value equal to a limit value from the target expert probability matrix to obtain a target element, wherein the limit value comprises a maximum value or a minimum value; and
determining the feature extraction strategy corresponding to the target element as the target feature extraction strategy.

6. The method according to claim 1, wherein the obtaining first intermediate feature data according to an image to be identified comprises:
processing the image to be identified to obtain respective object feature data of a plurality of image blocks to be identified;
processing predetermined data to obtain first category feature data;
obtaining fourth intermediate feature data according to the respective object feature data of the plurality of image blocks to be identified and the first category feature data; and
processing the fourth intermediate feature data to obtain the first intermediate feature data.

7. The method according to claim 6, wherein the processing the fourth intermediate feature data to obtain the first intermediate feature data comprises:
processing the fourth intermediate feature data based on an attention strategy, so as to obtain the first intermediate feature data.

8. The method according to claim 7, wherein the first intermediate feature data is obtained by processing the fourth intermediate feature data using an expected attention unit of a deep learning model.

9. The method according to claim 1, wherein the processing the first intermediate feature data based on the target feature extraction strategy, so as to obtain second intermediate feature data comprises:
extracting at least one of a global feature and a local feature of the first intermediate feature data based on the target feature extraction strategy, so as to obtain the second intermediate feature data.

10. The method according to claim 9, wherein the extracting at least one of a global feature and a local feature of the first intermediate feature data based on the target feature extraction strategy, so as to obtain the second intermediate feature data comprises:
determining at least one expert unit corresponding to the target feature extraction strategy from a plurality of expert units contained in a deep learning model, so as to obtain at least one target expert unit, wherein the expert unit comprises at least one selected from a multi-head self-attention layer or a feed forward network layer; and
processing the first intermediate feature data by using the at least one target expert unit, so as to obtain the second intermediate feature data.

11. The method according to claim 1, wherein the second intermediate feature data comprises second category feature data;
wherein the obtaining a multi-task identification result for the image to be identified according to the second intermediate feature data comprises:
determining, according to the second category feature data, category probability values of the image to be identified respectively belonging to a plurality of tasks, so as to obtain a plurality of category probability values; and
obtaining the multi-task identification result for the image to be identified according to the plurality of category probability values.

12. A method of training a deep learning model, comprising:
obtaining first intermediate sample feature data according to a sample image;
selecting a sample feature extraction strategy having a greatest matching degree with the sample image from a plurality of sample feature extraction strategies based on a selection strategy and the first intermediate sample feature data, so as to obtain a target sample feature extraction strategy;
processing the first intermediate sample feature data based on the target sample feature extraction strategy, so as to obtain second intermediate sample feature data;
obtaining a multi-task identification result for the sample image according to the second intermediate sample feature data; and
training the deep learning model by using the multi-task identification result for the sample image and a label value of the sample image, so as to obtain a trained deep learning model.

13. The method according to claim 12, wherein the selecting a sample feature extraction strategy having a greatest matching degree with the sample image from a plurality of sample feature extraction strategies based on a selection strategy and the first intermediate sample feature data, so as to obtain a target sample feature extraction strategy comprises:
obtaining third intermediate sample feature data based on the selection strategy and the first intermediate sample feature data; and
selecting the sample feature extraction strategy having the greatest matching degree with the sample image from the plurality of sample feature extraction strategies according to the third intermediate sample feature data, so as to obtain the target sample feature extraction strategy.

14. The method according to claim 13, wherein the obtaining third intermediate sample feature data based on the selection strategy and the first intermediate sample feature data comprises:
determining a selection matrix according to the selection strategy;
determining an intermediate sample matrix according to the first intermediate sample feature data;
determining a sample expert probability matrix according to the selection matrix and the intermediate sample matrix, wherein the sample expert probability matrix comprises sample elements respectively corresponding to the plurality of sample feature extraction strategies, and an element value of the sample element indicates a probability that the sample feature extraction strategy is selected; and
determining the sample expert probability matrix as the third intermediate sample feature data,
wherein the determining a sample expert probability matrix according to the selection matrix and the intermediate sample matrix comprises:
multiplying the selection matrix by the intermediate sample matrix to obtain the sample expert probability matrix,
wherein the selecting a sample feature extraction strategy having a greatest matching degree with the sample image from the plurality of sample feature extraction strategies according to the third intermediate sample feature data, so as to obtain the target sample feature extraction strategy comprises:
determining a sample element having a sample element value equal to a limit value from the sample expert probability matrix, so as to obtain a target sample element, wherein the limit value comprises a maximum value or a minimum value; and
determining a sample feature extraction strategy corresponding to the target sample element as the target sample feature extraction strategy.

15. The method according to claim 12, wherein the obtaining first intermediate sample feature data according to a sample image comprises:
processing the sample image to obtain respective sample object feature data of a plurality of sample image blocks;
processing predetermined sample data to obtain first sample category feature data;
obtaining fourth intermediate sample feature data according to the respective sample object feature data of the plurality of sample image blocks and the first sample category feature data; and
processing the fourth intermediate sample feature data to obtain the first intermediate sample feature data,
wherein the processing the fourth intermediate sample feature data to obtain the first intermediate sample feature data comprises:
processing the fourth intermediate sample feature data based on an attention strategy, so as to obtain the first intermediate sample feature data,
wherein the deep learning model comprises a backbone module, the backbone module comprises at least one backbone sub-module connected in cascade, and the backbone sub-module comprises an attention unit;
wherein the processing the fourth intermediate sample feature data based on an attention strategy, so as to obtain the first intermediate sample feature data comprises:
processing the fourth intermediate sample feature data by using an expected attention unit in the backbone module, so as to obtain the first intermediate sample feature data,
wherein the processing the first intermediate sample feature data based on the target sample feature extraction strategy, so as to obtain second intermediate sample feature data comprises:
extracting at least one of a global feature and a local feature of the first intermediate sample feature data based on the target sample feature extraction strategy, so as to obtain the second intermediate sample feature data,
wherein the backbone sub-module further comprises a plurality of expert units, and the expert unit comprise at least one selected from a multi-head self-attention layer or a feed forward network layer;
wherein the extracting at least one of a global feature and a local feature of the first intermediate sample feature data based on the target sample feature extraction strategy, so as to obtain the second intermediate sample feature data comprises:
determining at least one expert unit corresponding to the target sample feature extraction strategy from the plurality of expert units, so as to obtain at least one target sample expert unit; and
processing the first intermediate sample feature data by using the at least one target sample expert unit, so as to obtain the second intermediate sample feature data,
wherein the backbone module comprises M backbone sub-modules connected in cascade, where M is an integer greater than or equal to 1;
wherein the backbone sub-module further comprises an expert selection unit;
wherein the processing the first intermediate sample feature data by using the at least one target sample expert unit, so as to obtain the second intermediate sample feature data comprises:
for M=1,
processing the first intermediate sample feature data by using the target sample expert unit of a first level, so as to obtain fifth intermediate sample feature data of the first level; and
obtaining the second intermediate sample feature data according to the fifth intermediate sample feature data of the first level;
for M>1 and m>1,
processing sixth intermediate sample feature data of an m^{th} level by using the target sample expert unit of the m^{th} level, so as to obtain fifth intermediate sample feature data of the m^{th} level, wherein the sixth intermediate sample feature data of the m^{th} level is obtained by processing the fifth intermediate sample feature data of an (m−1)^{th} level using an attention unit of the m^{th} level, and the target sample expert unit of the m^{th} level is determined according to a result obtained by processing the fifth intermediate sample feature data of the (m−1)^{th} level using an expert selection unit of the m^{th} level; and
obtaining the second intermediate sample feature data according to the fifth intermediate sample feature data of an N^{th} level, where N is an integer greater than or equal to 1 and less than M,
wherein the target sample expert unit comprises a target multi-head self-attention layer and a target feed forward network layer;
wherein the processing sixth intermediate sample feature data of an m^{th} level by using a target sample expert unit of the m^{th} level, so as to obtain fifth intermediate sample feature data of the m^{th} level comprises:
processing the sixth intermediate sample feature data of the m^{th} level by using the target multi-head self-attention layer of the m^{th} level, so as to obtain seventh intermediate sample feature data of the m^{th} level; and
processing the seventh intermediate sample feature data of the m^{th} level by using the target feed forward network layer of the m^{th} level, so as to obtain the fifth intermediate sample feature data of the m^{th} level.

16. The method according to claim 12, wherein the second intermediate sample feature data comprises second sample category feature data;
wherein the obtaining a multi-task identification result for the sample image according to the second intermediate sample feature data comprises:
determining, according to the second sample category feature data, category probability values of the sample image respectively belonging to a plurality of tasks, so as to obtain a plurality of sample category probability values; and
obtaining the multi-task identification result for the sample image according to the plurality of sample category probability values,
wherein the deep learning model comprises a category classification module;
wherein the determining, according to the second sample category feature data, category probability values of the sample image respectively belonging to a plurality of tasks, so as to obtain a plurality of sample category probability values comprises:
processing the second sample category feature data and determining the category probability values of the sample image respectively belonging to the plurality of tasks by using the category classification module, so as to obtain the plurality of sample category probability values,
wherein the deep learning model comprises a preprocessing module, and the preprocessing module comprises an object processing unit and a category processing unit;
wherein the sample object feature data is obtained by processing the sample image block using the object processing unit;
wherein the first sample category feature data is obtained by processing the predetermined sample data using the category processing unit.

17. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

18. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 12.

19. A non-transitory computer-readable storage medium having computer instructions therein, wherein the computer instructions are configured to cause a computer to implement the method of claim 1.

20. A non-transitory computer-readable storage medium having computer instructions therein, wherein the computer instructions are configured to cause a computer to implement the method of claim 12.
